(19) United States
(12) Patent Application Publication
(10) Pub. No.: US 2026/0119623 A1
(43) Pub. Date: Apr. 30, 2026

(54) DYNAMIC SECURITY EVENTS FRAMEWORK FOR ADAPTIVE AUTHENTICATION

(71) Applicant: WORKDAY, INC., Pleasanton, CA (US)

(72) Inventors: Angelo RAUSEO, San Francisco, CA (US); Daniel MCGROGAN, Dublin (IE); Lavanya PAGOLU, Pleasanton, CA (US); Srinivas CHALLA, San Ramon, CA (US); Valeri Lanard, Livermore, CA (US); Bhagwan RAJPUT, San Ramon, CA (US); Mario NIEBLA, Encinitas, CA (US); Frederico VALENTE, Navan (IE); Jennifer WONG, San Ramon, CA (US); Subha GOPALAKRISHNAN, San Ramon, CA (US)

(21) Appl. No.: 18/931,143

(22) Filed: Oct. 30, 2024

(51) Int. Cl. G06F 21/31

(52) U.S. Cl. CPC G06F 21/31

(57) ABSTRACT

In some implementations, the techniques described herein relate to a method including: receiving a stream of security events from a plurality of event generators; generating security signals based on the security events, the security signals including a subset of the security events; aggregating and correlating the security signals using a signal source; evaluating the security signals and determining risk levels using a plurality of independent processors; determining that action is required based on a combined output of the security signals and determined risk levels; and executing a security response responsive to the action.

### BACKGROUND

Authentication systems protect sensitive data and resources in enterprise software environments. However, the security landscape is constantly evolving, with attackers becoming increasingly sophisticated in their pursuit of unauthorized access. Traditional static or manually defined authentication methods, while providing a baseline level of security, often struggle to adapt to the diverse and rapidly changing threat landscape. This creates a challenge for systems seeking to balance robust security measures with user experience, as overly rigid authentication processes can result in workarounds that may compromise security. Furthermore, the increasing volume and variety of security signals generated across complex software stacks present both an opportunity and a challenge in effectively leveraging this information to enhance authentication processes.

### BRIEF DESCRIPTION OF THE DRAWINGS

FIG. 1 is a block diagram of a system for detecting dynamic security events and providing adaptive authentication according to some example embodiments.

FIG. 2 is a flow diagram illustrating a method for dynamic security event processing and adaptive authentication.

FIG. 3 is a flow diagram illustrating a method for converting raw events to processed events.

FIG. 4 is a flow diagram illustrating a method for analyzing security events and generating security signals using extensible analyzers.

FIG. 5 is a flow diagram illustrating a method for processing and enriching security signals within a dynamic security events framework.

FIG. 6 is a flow diagram illustrating a method for processing security signals and making security decisions within a dynamic security events framework.

FIG. 7 is a block diagram of a computing device according to some implementations of the disclosure.

### DETAILED DESCRIPTION

In some implementations, the techniques described herein relate to a method including: receiving a stream of security events from a plurality of event generators; generating security signals based on the security events, the security signals including a subset of the security events; aggregating and correlating the security signals using a signal source; evaluating the security signals and determining risk levels using a plurality of independent processors; determining that action is required based on a combined output of the security signals and determined risk levels; and executing a security response responsive to the action.

In some implementations, the techniques described herein relate to a method, wherein receiving a stream of security events includes: collecting raw events from the plurality of event generators; ingesting the raw events to a stream; enriching the ingested events; normalizing the enriched events; and filtering the normalized events.

In some implementations, the techniques described herein relate to a method, wherein generating security signals based on the security events includes: receiving normalized events; distributing the normalized events to analyzers including one or more of a bot detection module, a machine learning profiler module, and an anomaly detection module; analyzing the distributed events with the analyzers; generating the security signals based on output from the analyzers; and transmitting the generated security signals to the signal source.

In some implementations, the techniques described herein relate to a method, wherein aggregating and correlating the security signals includes: receiving the security signals at the signal source; collecting and aggregating the received signals; correlating the aggregated signals to identify patterns; enriching the correlated signals with context data; and routing the enriched signals to the plurality of independent processors.

In some implementations, the techniques described herein relate to a method, wherein evaluating the security signals includes: receiving correlated signals at the plurality of independent processors; evaluating the correlated signals for immediate threats; and evaluating the correlated signals for in-depth analysis.

In some implementations, the techniques described herein relate to a method, wherein determining that action is required includes: comparing the determined risk levels against predefined thresholds or policies; determining a confidence level of a risk assessment; and proceeding to execute the security response if the risk meets or exceeds an action threshold.

In some implementations, the techniques described herein relate to a method, wherein executing the security response includes: selecting a specific response from a predefined set of actions based on a nature and severity of a detected risk; interacting with system components to implement the selected response; logging the executed response for auditing purposes; and recording a response to the action.

In some implementations, the techniques described herein relate to a non-transitory computer-readable storage medium and device for performing the above methods.

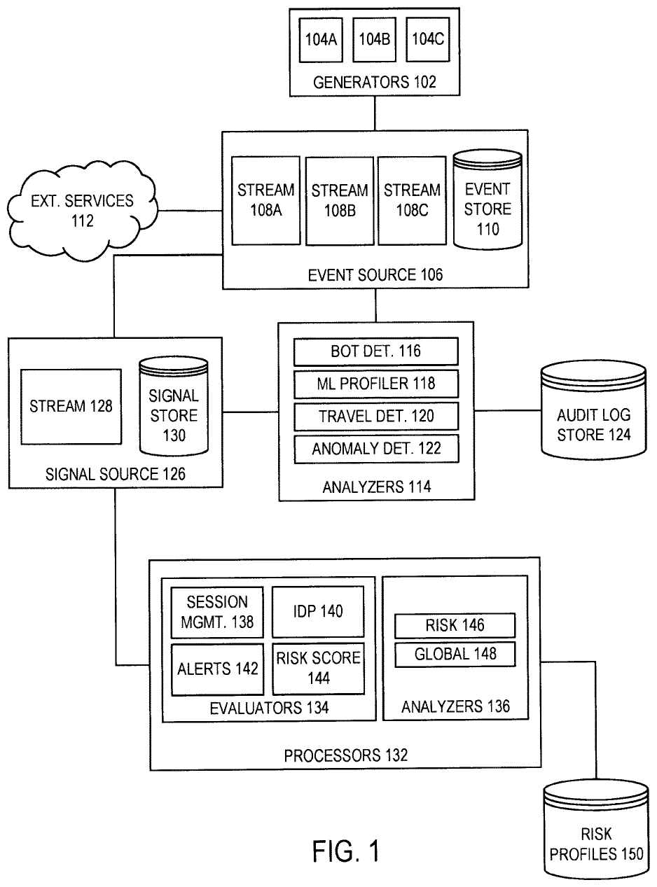

FIG. 1 is a block diagram of a system for detecting dynamic security events and providing adaptive authentication according to some example embodiments.

In some implementations, system 100 includes generators 102 that communicate with an event source 106. The generators 102 comprise multiple individual generators 104A, 104B, and 104C, which serve as sources of raw security-related data within the system.

In some implementations, the individual generators (104A, 104B, 104C) are configured to capture and emit raw events or signals generated by security and authentication processes. For example, these events can vary from basic login attempts to complex user behavior patterns and system anomalies. The generators 102 produce a continuous stream of data points that can be utilized for security analysis. The generators 102 are communicatively coupled to the event source 106 and transmit security-related raw data from the individual generators (104A, 104B, 104C) into the event source 106 for further processing.

Various examples of individual generators are described briefly herein. In a first example, session managers can track user sessions, providing information about login attempts and user activities. In a second example, mobile applications can generate events related to device information and user behavior patterns. In other examples, identity providers (IDPs) may serve as generators, managing user identities and supplying data about authentication attempts and profile changes. In a third example, risk services could generate risk scores based on factors like user behavior and network characteristics. In a fourth example, user interfaces might generate events related to user actions and input patterns, while log systems could capture system events and operational data across the infrastructure. Additionally, network devices such as routers and firewalls might act as generators, providing information about network traffic patterns and potential threats.

In some implementations, the use of an extensible array of potential generators allows the system to collect a comprehensive set of security-relevant data from multiple points within the infrastructure. In some implementations, new types of generators can be added to incorporate additional sources of security-relevant data as needed, enhancing the system's ability to adapt to evolving security landscapes and emerging threat vectors.

In some implementations, the event source 106 collects and processes raw security events from the generators 102. The event source 106 acts as an intermediary between the raw data produced by the individual generators (104A, 104B, 104C) of generators 102 and the subsequent analysis stages of the system. In some implementations, the event source 106 includes various subcomponents including a streams (108A, 108B, 108C) and an event store 110, thus supporting both real-time event processing via event streams and persistent storage of event data for later analysis or auditing purposes.

In some implementations, a given stream (e.g., stream 108A) comprises a real-time data pipeline within the event source 106. A stream can be implemented using stream processing technologies designed to handle high-volume, continuous data flows. In some implementations, streams provide a mechanism for ingesting the raw events and signals emitted by the generators 102, capable of handling varying data formats and volumes from the diverse set of generators. As events enter the stream 108a, they can be normalized into a standardized format, enabling consistent downstream processing by allowing the system to treat events from disparate sources in a uniform manner.

In some implementations, a given stream can be configured to perform initial filtering or enrichment of the incoming data. This can involve removing irrelevant or low-quality events, or augmenting events with additional context or metadata. Such preprocessing helps to reduce noise and improve the signal-to-noise ratio of the data flowing through the system. The stream processing nature of this component allows for real-time analysis and rapid response to emerging security threats, as events can be processed as soon as they are generated.

In some implementations, the event store 110 serves as a persistent storage mechanism for the processed events. In some implementations, the event store 110 utilizes a database or data storage system optimized for high-write throughput and efficient querying of time-series data. The event store 110 supports both real-time and historical analysis of security events. It allows the system to maintain a comprehensive record of all security-related activities, which can be valuable for forensic analysis, compliance reporting, and long-term trend analysis.

As illustrated, the use of both streams (108A, 108B, 108C) and an event store 110 within the event source 106 comprises a lambda architecture, where data can be processed in both real-time (via the stream) and batch (via the persistent store) modes. This dual approach provides flexibility in how the system can analyze and respond to security events, allowing for both immediate actions based on real-time data and more complex analyses that may require historical context. As illustrated, the event source 106 is communicatively coupled to external services 112. As such, the system 100 can integrate with external data sources or processing capabilities. In some implementations, these external services 112 encompass a range of third-party or specialized systems that enhance the overall security posture of the framework.

Various examples of external services 112 are described briefly herein. In a first example, threat intelligence feeds can provide up-to-date information on known threats, vulnerabilities, and malicious actors. By integrating such services, the system can enrich its event data with broader contextual information, potentially improving its ability to detect and respond to sophisticated or emerging threats. In a second example, external authentication or identity verification systems allow the framework to leverage additional identity assurance mechanisms when processing authentication-related events.

In some implementations, the external services 112 provide specialized analytics capabilities. For instance, they might offer advanced machine learning models or algorithms that can be applied to the event data to detect complex patterns or anomalies that may not be easily identifiable through traditional rule-based approaches. This could include services for behavioral biometrics analysis, natural language processing for analyzing text-based events, or specialized fraud detection algorithms.

The external services 112 might also encompass regulatory compliance checking services. These could help ensure that the security events and responses generated by the system align with relevant industry standards or legal requirements. Additionally, in some implementations, the external services 112 provide geolocation or Internet Protocol (IP) intelligence services. These allow the system to enrich events with geographical context, potentially aiding in the detection of suspicious access patterns or helping to enforce location-based security policies.

The integration of external services 112 allows the system 100 to adapt to new threats and leverage emerging technologies without requiring significant changes to the core architecture. This flexibility is beneficial in the rapidly evolving landscape of cybersecurity, where new threats and defensive technologies emerge constantly.

In some implementations, the interaction between the event source 106 and external services 112 involves implementing secure communication protocols to protect potentially sensitive event data, managing API keys or other authentication mechanisms for accessing the external services, and handling rate limiting or other constraints imposed by these services. The system 100 may also implement fallback mechanisms or degraded operation modes in case external services become unavailable. This ensures that the core functionality of the security framework isn't compromised by the failure of an external dependency. Additionally, the system might implement caching or local replication of certain external data to improve performance and resilience.

As illustrated, the system 100 includes analyzers 114 communicatively coupled to the event source 106. The analyzers 114 are responsible for processing the normalized events from the event source 106 and deriving insights from the raw data. In some implementations, the analyzers 114 comprise several specialized modules, each designed to focus on different aspects of security analysis. Similar to generators 102, the number and type of analyzers in analyzers 114 is extensible and not limiting.

As illustrated in FIG. 1, the analyzers 114 include four analyzer modules (although the specific number is not limited): bot detection 116, machine learning profiler 118, travel detection 120, and anomaly detection 122. These modules work in concert to provide a comprehensive analysis of the security events flowing through the system. In some implementations, the architecture supports the addition of other specialized analyzers as needed, providing flexibility and extensibility to the framework.

In some implementations, the bot detection module 116 is configured to identify automated or programmatic interactions with the system. This module employs various techniques to distinguish between human and bot activities. It may analyze patterns in user behavior, request characteristics, and other signals to detect potential bot-driven activities. The bot detection capabilities are beneficial in modern security frameworks, as many attacks and fraudulent activities are carried out by automated systems. The bot detection module 116 employs a multi-faceted approach to distinguish between human and automated activities, utilizing techniques such as request pattern analysis, behavioral analysis, device fingerprinting, CAPTCHA challenges, traffic source analysis, and session behavior analysis. It may also leverage machine learning models to identify complex patterns indicative of bot activity. These capabilities are crucial in modern security frameworks, as they help mitigate various automated threats including credential stuffing, content scraping, denial of service attempts, and fraudulent account creation. By working in conjunction with other system components like the risk score module 144 and analyzers 136, the bot detection module contributes to a comprehensive security assessment and response strategy.

The machine learning profiler 118 can use machine learning techniques to build and maintain user behavior profiles. This profiler uses historical data to establish baseline behaviors for users or entities within the system. By continuously updating these profiles, the ML profiler can detect anomalies that deviate from established patterns. This approach allows for a more nuanced and adaptive form of security analysis, capable of identifying subtle changes in behavior that might indicate a compromised account or insider threat.

In some implementations, the machine learning profiler 118 performs feature engineering to extract relevant attributes from raw event data, such as login frequencies, typical session durations, and common IP ranges. These features can then be normalized using techniques like min-max scaling to ensure consistent ranges across different attributes. In some implementations, the machine learning profiler can include an ensemble model combining decision trees and neural networks. The model can be continuously updated using online learning algorithms, allowing it to adapt to gradual changes in user behavior over time.

The travel detection module 120 is specialized in identifying potentially suspicious patterns in user location data. This module can analyze login attempts and user activities to detect scenarios that suggest physically impossible travel, which may indicate account compromise. For instance, if a user appears to log in from geographically distant locations within an impossibly short time frame, this module would flag such activity as suspicious.

The anomaly detection module 122 can act as a catch-all for identifying unusual patterns or behaviors that may not be caught by the other, more specialized modules. This module can utilize statistical and machine learning techniques to establish normal baselines across various dimensions of system activity. It then flags events or patterns that significantly deviate from these baselines. The anomaly detection module can be particularly effective at identifying novel or previously unseen types of suspicious activity, making it a key component in the system's ability to adapt to new and emerging threats.

Various examples of algorithms used by each analyzer module are described briefly herein. In a first example, the bot detection module 116 can use rate limiting analysis to track request frequencies and flag those exceeding predefined thresholds. In a second example, the machine learning profiler 118 might employ ensemble modeling or clustering algorithms like K-means to group similar user behaviors. In other examples, the travel detection module 120 could utilize the Haversine formula to calculate distances between login locations, while the anomaly detection module 122 might use Gaussian Mixture Models for modeling normal behavior distributions.

While not explicitly shown in FIG. 1, the analyzers 114 component may include additional types of analysis modules. For example, it may include modules dedicated to risk scoring, which calculate dynamic risk scores based on various factors such as user history, current context, and threat intelligence. Additionally, it can include modules for time series analysis, focused on detecting suspicious trends or sudden changes in activity patterns over time.

In some implementations, the extensible structure of the analyzers 114 component allows for easy integration of new analysis techniques as they are developed, or as new threat vectors emerge. This extensibility is important in the rapidly evolving landscape of cybersecurity, where new types of attacks and defensive measures are constantly emerging.

As illustrated, the analyzers 114 component is communicatively coupled to multiple streams, and are thus able to process data in real-time as well as perform batch analysis on historical data. This dual-mode operation allows the system to provide both immediate threat detection and deeper, more comprehensive analysis that may require broader context or longer time frames.

The analyzers 114 produce a set of higher-level signals or insights that offer a nuanced understanding of the security context. These signals, more abstract and semantically rich than raw events, encapsulate complex patterns and assessments. For instance, instead of merely indicating a failed login attempt, a signal might convey the likelihood of an account compromise based on factors like login location, device characteristics, and historical user behavior. These enriched signals enable more sophisticated decision-making in subsequent system components, allowing for context-aware security responses that balance risk mitigation with user experience.

In some implementations, the analyzers 114 are connected to an audit log store 124. Using this connection, the system can maintain detailed records of the analysis process itself. This audit trail allows for post-hoc investigation of security incidents, supports continuous improvement of the analysis modules, and can be valuable for compliance purposes.

The system architecture may support horizontal scaling of the analyzers 114 component to handle increasing volumes of data or to maintain low latency in analysis as the system grows. This could involve deploying multiple instances of each analyzer module and distributing the workload across them.

In some implementations, the analyzers 114 component incorporates feedback loops, both internal and external. Internally, the results of one analysis module might inform or trigger additional analysis by another module. Externally, the actions taken based on the analyzers'outputs might generate new events that feed back into the analysis process, allowing the system to learn and adapt over time.

As illustrated in FIG. 1, the system 100 includes a signal source 126 communicatively coupled to the analyzers 114. The signal source 126 serves as a central hub for managing the signals produced by the analyzers 114. In some implementations, the signal source 126 comprises two main components: a stream 128 and a signal store 130.

In some implementations, the stream 128 is a real-time data pipeline that receives and processes signals from the analyzers 114. It handles the continuous flow of higher-level security insights generated by the various analysis modules. The stream 128 is configured to manage high volumes of signal data, ensuring that critical security information is processed and made available to downstream components with minimal latency. The signal store 130 is a persistent storage system for the processed signals. It maintains a historical record of all signals generated by the analyzers 114. This storage allows for retrospective analysis, trend identification, and auditing of security-related activities over extended periods.

In some implementations, the signal source 126 performs several functions in the system 100. First, it can collect output signals from the various analyzers 114, ensuring that insights from different types of analysis are consolidated in a single location. The component correlates related signals, combining information from multiple sources to provide a more comprehensive view of the security context. This correlation process enhances the overall understanding of potential security threats by identifying patterns or relationships that may not be apparent when signals are considered in isolation.

Additionally, the signal source 126 may enrich signals with additional context or metadata. This enrichment process adds value to the raw signals by incorporating relevant information from other parts of the system or external sources. The enriched signals provide a more detailed and actionable representation of the security situation.

In some implementations, the signal source 126 is responsible for routing relevant signals to appropriate processors 132 based on configured rules or policies. This routing ensures that the right information reaches the decision-making components of the system in a timely manner.

As illustrated, the system 100 includes processors 132 communicatively coupled to the signal source 126. The processors 132 represent the decision-making and action-taking component of the system. In some implementations, the processors 132 consist of two main subcomponents: evaluators 134 and analyzers 136. These subcomponents work together to consume signals from the signal source 126 and determine appropriate responses based on the current security context.

In some implementations signal source 126 is communicatively coupled to the event source 106. In this context, the signal source 126 can act an event stream for event source 106. This allow analyzers 114 to consume and combine the rich signal events produced by signal source 126 (via event source 106).

The evaluators 134 are responsible for assessing the signals and making initial determinations about their significance and potential impact. It includes several modules including, without limitation, session management 138, IDP 140, alerts 142, and risk score 144.

In some implementations, the session management module 138 is dedicated to evaluating signals related to user sessions. This module tracks and analyzes session-related information, such as login attempts, session durations, and user activities within a session. It determines whether current session behaviors align with established norms or if they exhibit suspicious patterns that may require intervention. The IDP module 140 focuses on signals pertaining to user authentication and identity. It evaluates authentication attempts, user profile changes, and other identity-related events. This module plays a role in detecting potential account compromises or unauthorized access attempts. The alerts module 142 is responsible for generating and managing security alerts based on the evaluated signals. It determines which signals or combinations of signals warrant immediate attention and creates appropriate alerts for security personnel or other system components. The risk score module 144 calculates dynamic risk scores based on the evaluated signals and other contextual information. These risk scores provide a quantitative measure of the potential security threat associated with specific users, sessions, or activities.

The analyzers 136 perform more in-depth analysis of the signals and the initial evaluations. It includes three specialized modules: risk module 146, global module 148, and risk profiles module 150.

In some implementations, the risk module 146 conducts comprehensive risk assessments based on the signals, risk scores, and other relevant data. It may employ advanced algorithms or machine learning models to identify complex risk patterns that may not be immediately apparent from individual signals. The global module 148 takes a broader view of the security landscape, analyzing signals and evaluations across the entire system. This module is responsible for identifying large-scale patterns, trends, or coordinated threats that may only be visible when considering the full scope of system activity. The risk profiles module 150 maintains and updates risk profiles for users, entities, or system components based on ongoing analysis. These profiles evolve over time as new signals are processed, allowing the system to adapt its risk assessments to changing behavior patterns and emerging threats.

In some implementations, the processors 132 component is extensible, allowing organizations to define their own policies and response strategies based on their specific security requirements and risk tolerance. This flexibility is beneficial for adapting the system to different operational environments and evolving threat landscapes.

The processors 132 not only consider real-time signals but can also incorporate historical data in their decision-making process. This allows the system to learn from past interactions and refine its security decisions over time. For example, the system may recognize patterns in a user's login behavior or gradually adjust risk thresholds based on long-term trends in security signals.

In some implementations, the interaction between the evaluators 134 and analyzers 136 subcomponents allows for a multi-layered approach to security decision-making. The evaluators 134 provide rapid, real-time assessments that can trigger immediate responses to clear security threats. Meanwhile, the analyzers 136 perform more complex, contextual analyses that can uncover subtle patterns or emerging threats over time.

In some implementations, the session management module 138 within the evaluators 134 can continuously monitor session-related signals to detect anomalies or suspicious activities. This module may track factors such as session duration, geographic location of access, types of actions performed, and patterns of data access.

In some implementations, the IDP module 140 can interact with external identity management systems and internal user databases to verify and monitor user identities. It evaluates signals related to authentication events, looking for patterns that might indicate credential stuffing attacks, brute force attempts, or the use of stolen credentials.

In some implementations, the alerts module 142 is responsible for translating evaluated signals and analysis results into actionable notifications. It applies predefined rules and thresholds to determine when and how to generate alerts. These alerts can be targeted to different recipients based on their nature and severity—from automated system responses to notifications for security analysts.

The risk score module 144 aggregates and weighs various risk factors to produce a numerical representation of the current risk level. This score may be calculated for individual users, sessions, transactions, or system-wide activities. The risk scoring algorithm considers factors such as user behavior patterns, device and network characteristics, geographic location, and historical security events.

Within the analyzers 136 subcomponent, the risk module 146 performs deeper, more contextual analysis of security risks. This module may employ complex analytical techniques, including machine learning models, to identify subtle risk indicators and emerging threat patterns. It may analyze longer-term trends in user behavior, correlate seemingly unrelated events across different parts of the system, and incorporate external threat intelligence to provide a more nuanced understanding of security risks.

The global module 148 takes a system-wide perspective on security analysis. It aggregates and correlates signals, evaluations, and analysis results from across the entire framework to identify large-scale patterns or coordinated threats. This module is particularly important for detecting distributed attacks, system-wide vulnerabilities, or gradual changes in the overall security posture.

The risk profiles module 150 maintains dynamic, evolving profiles of entities within the system, such as users, devices, or applications. These profiles capture historical behavior patterns, risk scores, security events, and other relevant data. As new signals and analysis results are processed, the risk profiles module updates these profiles in real-time.

In some implementations, the processors 132 component implements logging and auditing mechanisms to record all evaluations, analyses, and decisions made. This audit trail is useful for post-incident investigations, compliance reporting, and continuous improvement of the system's decision-making processes.

While the system can operate autonomously, it also allows for customer configuration and guidance. Administrators can adjust sensitivity levels, define custom rules, or prioritize certain types of signals based on their organization's specific security needs. The system can also provide recommendations to administrators, suggesting potential policy adjustments based on observed patterns and detected anomalies.

Various functional aspects of the above-described systems are described next with respect to the following flow diagrams.

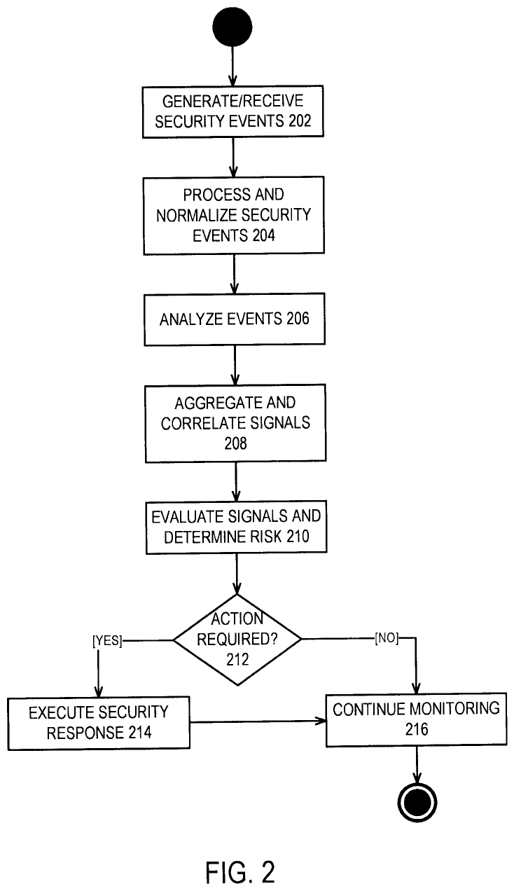

FIG. 2 is a flow diagram illustrating a method for dynamic security event processing and adaptive authentication.

In step 202, the method can include generating and receiving security events.

In this step, the method begins with various components of the system producing security-relevant data. These components, acting as generators, may include session managers tracking user logins and activities, mobile applications reporting device information and user interactions, identity providers logging authentication attempts, user interfaces capturing user actions, log systems recording system events, and network devices reporting traffic patterns. Each generator creates events in its native format, which could range from simple timestamped actions to complex data structures containing multiple fields. The events generated might include user login attempts, password changes, resource access requests, network connection establishments, or any other activity that could be relevant from a security perspective. The method receives these diverse events through various input channels, which might include real-time streams, message queues, or application programming interface (API) endpoints. This continuous influx of security events forms the raw data foundation upon which the subsequent security analysis will be built.

In step 204, the method can include processing and normalizing security events.

In this step, the method can transform the heterogeneous event data into a standardized format that can be efficiently processed in later stages. The normalization can include parsing the raw event data, extracting relevant fields, and mapping them to a common schema. For example, a login event from an identity provider might be normalized to include fields such as timestamp, user ID, IP address, and authentication result, regardless of the original format. This step may also involve enrichment, where additional context is added to the events. For instance, IP addresses might be resolved to geographic locations, or user IDs might be linked to their associated roles or permissions. The method may also perform initial filtering at this stage, removing obviously irrelevant or low-quality events to reduce noise in the data stream. The processed and normalized events are then typically stored in a standardized format, ready for analysis.

In step 206, the method can include analyzing events.

In this step, each module of the analyzers sub-component can independently analyze the events. Each module is designed to analyze the events from a different perspective, deriving meaningful security insights. For example, a bot detection module might analyze patterns in user behavior and request characteristics, looking for signs of automated or programmatic interactions. This could involve examining the frequency and timing of actions, the uniformity of behaviors across multiple sessions, or the presence of known bot signatures. A machine learning profiler might build and maintain models of normal user behavior, continuously updating these models as new events are processed. It would then flag events that deviate significantly from these established patterns. A travel detection system might examine login locations and timestamps, identifying physically impossible travel scenarios that could indicate account sharing or compromise. An anomaly detection mechanism might employ statistical techniques or machine learning algorithms to identify unusual patterns or behaviors that deviate from historical norms, potentially indicating new or evolving threats. Each analysis module processes the incoming events, applying its specialized algorithms and heuristics, and produces higher-level security signals. These signals represent more abstract and semantically rich interpretations of the raw events, encapsulating complex patterns or assessments derived from the analysis.

In step 208, the method can include aggregating and correlating signals.

As the method receives analyzed events, the method can combine these disparate signals into a cohesive and comprehensive view of the security landscape. The aggregation can include collecting related signals, potentially from different analysis modules or time periods, and grouping them together. For example, all signals related to a particular user or IP address might be aggregated. The correlating then examines these aggregated signals for meaningful patterns or relationships. This might involve time-based correlation, where the method looks for sequences of events that match known attack patterns. It could also include cross-domain correlation, where signals from different security domains (e.g., network traffic analysis and user behavior analysis) are combined to identify more complex threat scenarios. The method might employ various correlation techniques, from simple rule-based approaches to sophisticated machine learning algorithms that can identify subtle, non-obvious relationships between signals. The output of this step is a set of correlated signal groups that provide a more holistic representation of potential security threats or anomalies.

In step 210, the method can include evaluating signals and determining risk.

In this step, the method includes processing the aggregated and correlated signals to assess the overall security risk they represent. The evaluation can include applying a set of predefined rules or risk models to the signal data. These rules might consider factors such as the severity and reliability of individual signals, the historical context of the user or system involved, and the current threat landscape. For example, a single failed login attempt might be considered low risk, but multiple failed attempts from different geographic locations could indicate a higher risk of an attack. The method can calculate risk scores for different entities (users, devices, applications) or activities based on the evaluated signals. These risk scores could be continuous values or categorical ratings (e.g., low, medium, high risk). The risk determination might also involve predictive modeling, where the method attempts to forecast potential security issues based on current signals and historical patterns. The output of this step is a set of risk assessments that provide a quantitative or qualitative measure of the security threats indicated by the analyzed signals.

In step 212, the method can include determining if action is required.

In some implementations, the method can include comparing the determined risk levels against predefined thresholds or policies. These thresholds are typically set by security administrators based on the organization's risk tolerance and security requirements. The comparison might involve simple numeric comparisons (e.g., if the risk score exceeds a certain value) or more complex decision trees that consider multiple factors. For instance, a medium risk score might trigger action if it's associated with a high-privilege user account, but not for a standard user. The system might also consider the confidence level of the risk assessment, potentially requiring higher confidence for more severe actions. If the evaluated risk meets or exceeds the action threshold, the method can proceed to step 214 to execute a security response. If the risk falls below the threshold, the method can proceed to step 216 to continue monitoring.

In step 214, the method can include executing a security response.

This step is initiated when the method determines that action is required based on the evaluated risk. The specific response is typically selected from a predefined set of actions, with the choice depending on the nature and severity of the detected risk. For lower-risk situations, the response might involve subtle measures such as requiring additional authentication factors for the next login attempt or sending a notification to the user about suspicious activity. Moderate-risk scenarios might trigger more significant actions like temporarily restricting access to sensitive resources or requiring immediate password changes. In high-risk situations, the method might take more drastic measures such as immediately terminating all active sessions for the affected user, locking the account, or alerting the security operations team for manual intervention. The execution of the response typically involves interaction with various system components. For example, enforcing additional authentication might require communication with the identity management system, while restricting access would involve updating access control lists. The method usually logs all executed responses for auditing purposes, recording the rationale for the action, the specific measures taken, and their outcomes. When complete the method can proceed to step 216 to continue monitoring.

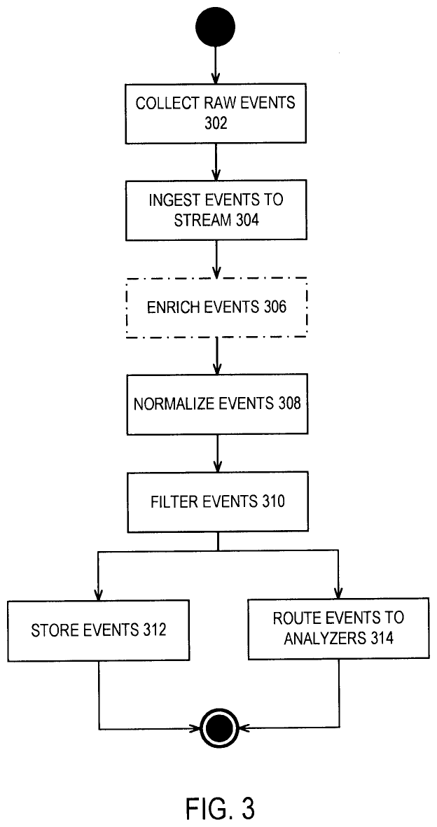

FIG. 3 is a flow diagram illustrating a method for converting raw events to processed events. In some implementations, the method of FIG. 3 may be performed by event source 106.

In step 302, the method can include collecting raw events.

In this step, the method can begin by actively gathering security-relevant data from various sources across the network and applications. These sources may include authentication systems logging login attempts, firewalls recording network traffic, intrusion detection systems flagging suspicious activities, and application servers noting user interactions. The collection typically involves setting up data pipelines or APIs to receive events in real-time or near-real-time. For example, a login event might be immediately sent to the collection system when a user attempts to access an application. The raw events at this stage are often in diverse formats, depending on their source. A firewall log entry might be in a proprietary format, while an application event could be in JavaScript Object Notation (JSON). The method can ingest these varied formats simultaneously.

In step 304, the method can include ingesting events to stream.

In this step, the method can include feeding the collected raw events into a high-throughput, low-latency streaming system. The streaming infrastructure is designed to handle large volumes of incoming data in real-time, ensuring that events are processed as they arrive without significant delay. This could be implemented using technologies like Apache Kafka®, Amazon Kinesis®, or similar distributed streaming platforms. As events are ingested, they are typically assigned metadata such as timestamps and unique identifiers. The stream may be partitioned based on event types, sources, or other criteria to facilitate parallel processing in subsequent steps. For instance, authentication events might be directed to one partition, while network traffic events go to another. The streaming system also often implements fault-tolerance mechanisms, such as data replication, to ensure no events are lost in case of system failures. This step is critical for maintaining the real-time nature of the security analysis, allowing for quick detection and response to potential threats.

In step 306, the method can include enriching events.

This optional step involves augmenting the raw event data with additional context or information to enhance its value for security analysis. Enrichment can take various forms depending on the type of event and the available external data sources. For a login event, enrichment might involve looking up the user's role and access privileges from an identity management system. For a network connection event, it could mean performing a geolocation lookup on the IP address or checking the address against known threat intelligence feeds. The enrichment might also involve correlating the event with recent historical data. For example, a login attempt might be enriched with information about the user's typical login patterns or recent failed attempts. This step often requires integration with various internal and external data sources and may involve API calls or database lookups. The goal of enrichment is to provide a more comprehensive context for each event, enabling more accurate and insightful analysis in subsequent steps.

In step 308, the method can include normalizing events.

This step transforms the diverse incoming events into a standardized format that can be efficiently processed by subsequent analysis stages. Normalization typically involves parsing the raw event data (which may be in various formats like JSON, XML, or proprietary log formats) and mapping it to a common schema. For example, all authentication events, regardless of their source, might be normalized to include fields such as timestamp, user ID, device ID, authentication result, and IP address. This process often involves field extraction, where relevant information is pulled out of complex data structures or unstructured text. It may also include data type conversion, ensuring that similar fields across different event types are represented consistently (e.g., ensuring all timestamps are in UTC).

In step 310, the method can include filtering events.

After normalization, the events pass through a filtering stage where irrelevant or low-value events are removed from the stream. This step helps reduce noise and focus the analysis on the most security-relevant data. Filtering criteria might include removing duplicate events, excluding events from known safe sources, or dropping events that don't meet certain threshold criteria. For instance, the method may filter out routine successful authentication events unless they're from unusual locations or times. The filtering logic can be based on static rules defined by security administrators or dynamic rules that adapt based on the current security context. This step may also involve sampling techniques for high-volume event streams, ensuring that the volume of data doesn't overwhelm downstream processing capabilities while still maintaining a representative view of the security landscape.

In step 312, the method can include storing events.

This step includes persisting the processed events for future reference and analysis. The events, now normalized and filtered, are typically stored in a database or data storage system optimized for efficient querying of large volumes of time-series data. This could be a specialized security information and event management (SIEM) system, a distributed database like Elasticsearch®, or a cloud-based data warehouse. The storage system often implements data retention policies, determining how long different types of events are kept based on their importance and any regulatory requirements. It may also implement data compression and indexing strategies to optimize storage usage and query performance. Stored events serve multiple purposes: they allow for historical analysis, trend detection, and provide a comprehensive audit trail for security investigations or compliance reporting.

In step 314, the method can include routing events to analyzers.

This step includes directing the normalized and filtered events to appropriate analysis modules for deeper inspection. The routing decision is typically based on the event type, its attributes, or predefined routing rules. For example, authentication events might be routed to a user behavior analysis module, while network traffic events are sent to a threat detection analyzer. The routing system needs to ensure that events are delivered reliably and in a timely manner to the relevant analyzers. This might involve using message queues or publish-subscribe systems to manage the flow of events to multiple analyzers. The routing step may also implement load balancing to distribute events across multiple instances of the same analyzer type, ensuring efficient processing of high event volumes. By directing events to specialized analyzers, this step enables focused and efficient security analysis tailored to different types of security data and threat scenarios.

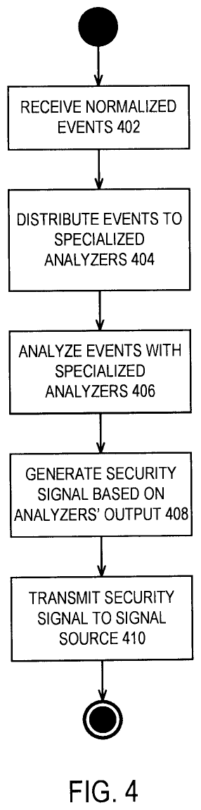

FIG. 4 is a flow diagram illustrating a method for analyzing security events and generating security signals using extensible analyzers. In some implementations, the method of FIG. 4 may be implemented by analyzers 114.

In step 402, the method can include receiving normalized events.

In this step, the method receives a stream of normalized security events. These events have already undergone initial processing, including normalization to a standard format, as discussed previously, which enables consistent handling across different event types. The normalized events typically contain key information such as timestamps, event types, source identifiers, and relevant security attributes, all structured in a predefined schema. For example, a normalized authentication event might include fields for timestamp, user ID, IP address, device identifier, and authentication result. The reception of these events often involves a queuing or streaming system designed to handle high-throughput data flows, ensuring that events can be processed as they arrive in real-time. This step may also involve preliminary checks to ensure the integrity and completeness of the received events, flagging or filtering out any malformed or corrupt data before it enters the analysis pipeline.

In step 404, the method can include distributing events to specialized analyzers.

This step involves routing the received events to appropriate specialized analysis modules based on their characteristics. The distribution typically employs a set of rules or a dynamic routing algorithm to determine which analyzer(s) should process each event. For instance, login events might be routed to both a user behavior analyzer and a credential stuffing detection module. Network traffic events could be sent to a DDoS detection analyzer and a network anomaly detector. The distribution system must be capable of handling high volumes of events and ensuring that each analyzer receives the events relevant to its function without becoming overwhelmed. This might involve implementing load balancing mechanisms to distribute events across multiple instances of the same analyzer type. The system may also prioritize certain event types or sources, ensuring that high-priority events are processed more quickly. This step is crucial for enabling parallel processing of events and ensuring that each event is analyzed by the most appropriate specialized modules.

In step 406, the method can include analyzing events with specialized analyzers.

In this step, each specialized analyzer processes the events it receives, applying specific algorithms and heuristics to detect patterns, anomalies, or indicators of potential security threats. The exact analysis performed varies depending on the analyzer type. A bot detection analyzer might examine patterns in request frequency, timing, and characteristics to identify automated activities. A user behavior analyzer could apply machine learning models to detect deviations from established user patterns. A travel analyzer would compare login locations and timestamps to flag physically impossible scenarios. Each analyzer typically maintains its own state and historical data to provide context for the current analysis. For example, a risk scoring analyzer might consider a user's historical behavior when evaluating the risk of a current action. The analysis often involves complex computations, potentially leveraging machine learning models, statistical analysis, or rule-based systems. The output of the analyzers is a transformed raw event data that can aid in identifying potential threats or anomalies that warrant attention.

In step 408, the method can include generating security signals based on analyzers'output.

This step involves synthesizing the outputs from various specialized analyzers into coherent security signals. Each analyzer produces its own set of findings or assessments based on the events it processed. The signal generation collates these outputs, potentially weighting or prioritizing them based on predefined criteria or dynamic rules. For instance, if both the user behavior analyzer and the travel detector flag an event as suspicious, it might generate a high-priority security signal. The generated signals are more semantically rich than the original events, encapsulating complex patterns or assessments. A signal might indicate a potential account compromise, a detected DDoS attack, or an emerging insider threat. The signal generation may also involve correlation across different analyzer outputs to identify more complex or subtle security issues. This step essentially distills the vast amount of event data and analysis results into actionable security intelligence.

In step 410, the method can include transmitting security signals to signal source.

In this step, the method includes sending the generated security signals to a centralized signal source for further processing and decision-making. The transmission typically occurs over a secure, high-reliability channel to ensure that critical security information is not lost or intercepted. The signals are usually structured in a standardized format that includes details such as the signal type, severity level, associated entities (e.g., users, IP addresses), timestamp, and a summary of the evidence that led to the signal's generation. The transmission might involve prioritization, ensuring that high-severity signals are sent and processed more quickly. It may also include mechanisms for handling transmission failures or delays, such as retries or local caching. As signals are transmitted, the method might also update relevant internal states or logs, maintaining a record of all generated signals for auditing or retrospective analysis purposes. This step bridges the gap between the analysis phase and the subsequent decision-making processes, ensuring that the insights gained from event analysis are promptly made available for security response actions.

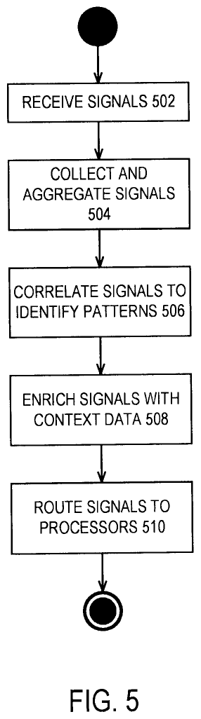

FIG. 5 is a flow diagram illustrating a method for processing and enriching security signals within a dynamic security events framework. In some implementations, the method of FIG. 5 may be performed by signal source 126.

In step 502, the method can include receiving signals.

In some implementations, the method begins by receiving incoming security signals from various specialized analyzers within the system. These signals represent higher-level security insights derived from the analysis of raw events. Each signal typically contains metadata, including its type (e.g., potential account compromise, unusual network activity, suspected insider threat), severity level, associated entities (such as user IDs, IP addresses, or system components), and a timestamp. The signals may also include contextual information about the events and analysis that led to their generation. This method might employ technologies like distributed message queues or streaming platforms to ensure reliable and scalable signal ingestion. As signals are received, the method may perform initial validation checks to ensure data integrity and completeness, flagging any malformed or suspect signals for further investigation or remediation.

In step 504, the method can include collecting and aggregating signals.

In this step, the method can collect related signals and combine them into coherent groups or clusters. The aggregation typically uses various criteria to determine which signals should be grouped together. These criteria might include temporal proximity (signals occurring within a specific time window), shared attributes (signals related to the same user, IP address, or system component), or thematic similarity (signals indicating related types of security threats). For instance, multiple failed login attempts from different locations for the same user account might be aggregated into a single potential account compromise incident. The aggregation helps to reduce noise and provide a more comprehensive view of potential security issues by consolidating related pieces of information. It may also involve applying initial analytics to the grouped signals, such as calculating aggregate risk scores or determining the overall severity of a group of related signals. This step is crucial for transforming a stream of individual signals into a more structured and manageable set of potential security incidents or trends.

In step 506, the method can include correlating signals to identify patterns.

In this step, the method analyzes the aggregated signals to uncover meaningful patterns, trends, or relationships that may not be apparent when considering signals in isolation. The correlation can employ various techniques, from rule-based approaches to machine learning algorithms. Time-based correlation might look for specific sequences of signals that match known attack patterns. For example, a series of signals showing unsuccessful login attempts followed by a successful login and then unusual data access patterns could indicate a successful account takeover. Cross-domain correlation might combine signals from different security domains, such as network traffic analysis and user behavior monitoring, to identify more complex threat scenarios. The method may also perform historical correlation, comparing current signal patterns with past incidents to identify recurring or evolving threats.

In step 508, the method can include enriching signals with context data.

This step involves augmenting the correlated signals with additional contextual information to enhance their value for decision-making. Enrichment typically draws from various internal and external data sources to provide a more comprehensive picture of the security context surrounding each signal or group of signals. For a signal indicating suspicious user activity, enrichment might involve retrieving the user's role and access history from an identity management system, recent device information from a device management database, and relevant organizational policies from a policy repository. External threat intelligence feeds might be consulted to check if any involved IP addresses or domains are associated with known threats. The enrichment may also involve real-time risk calculations, updating risk scores based on the latest context. This additional context helps security teams or automated decision-making systems better understand the full implications of each signal, enabling more informed and effective responses to potential threats.

In step 510, the method can include routing signals to processors.

In this step, the method can include directing the enriched and correlated signals to appropriate processing components for decision-making and potential action. The routing logic can consider factors such as signal type, severity, affected systems or users, and organizational policies. High-severity signals might be routed to real-time alerting systems and automated response mechanisms, while lower-priority signals could be directed to batch processing systems for trend analysis. The routing system can ensure that signals are delivered reliably and in a timely manner, especially for critical security issues. This might involve implementing quality of service mechanisms to prioritize the most urgent signals. The routing step may also involve load balancing to distribute signals across multiple processor instances, ensuring efficient handling of high signal volumes. Additionally, the system might implement fallback or redundancy mechanisms to ensure that critical signals are processed even if primary processors are unavailable. By effectively routing signals to the appropriate processors, this step enables the security system to respond to potential threats with the appropriate level of urgency and the most suitable type of action.

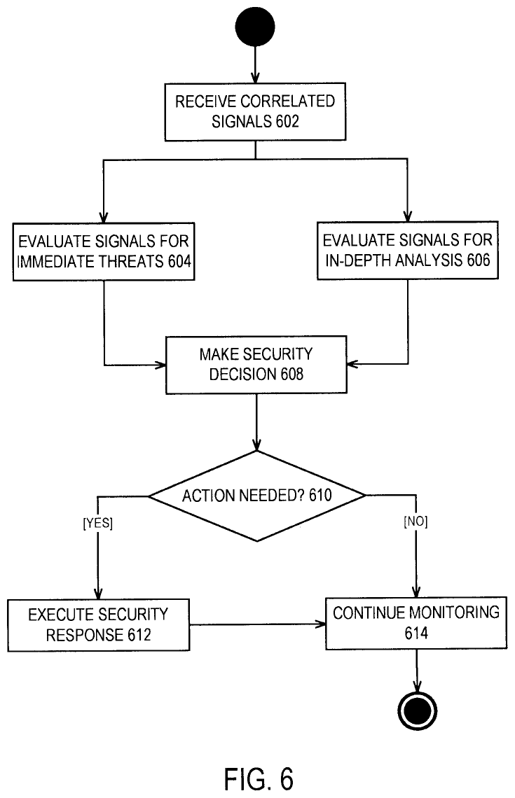

FIG. 6 is a flow diagram illustrating a method for processing security signals and making security decisions within a dynamic security events framework. In some implementations, the method of FIG. 6 may be performed by processors 132.

In step 602, the method can include receiving correlated signals.

In this step, the method can include receives a stream of correlated security signals from the signal source. As described, these signals have undergone aggregation, correlation, and enrichment in previous stages, providing a comprehensive view of potential security issues. Each correlated signal typically contains metadata, including the type of security concern it represents (e.g., potential data exfiltration, credential stuffing attempt, insider threat activity), a calculated severity or risk score, affected entities (such as user accounts, IP addresses, or system resources), and relevant contextual information. The signals may also include details of the correlation process, showing relationships between individual events or other signals that contributed to this higher-level insight. The reception process often employs a high-performance queuing or streaming system capable of handling a continuous flow of signals in real-time, ensuring that critical security information is processed without delay. As signals are received, the method may perform initial triage, prioritizing signals based on their severity or potential impact to ensure that the most critical issues are addressed first.

In step 604, the method can include evaluating signals for immediate threats.

In this step, the method can assess the received signals to identify any that require immediate attention or action. In some implementations, the evaluation typically employs a set of predefined rules or machine learning models trained to recognize patterns indicative of severe and imminent threats. For example, signals suggesting an ongoing data breach, a detected malware infection, or a sudden spike in failed login attempts might be flagged for immediate review. This evaluation often considers factors such as the signal's risk score, the criticality of affected systems or data, and the potential for rapid escalation of the threat. The process is designed to be fast and efficient, quickly separating urgent threats from those that can be subjected to more thorough analysis. Any signals identified as immediate threats are promptly forwarded to the decision-making step, potentially triggering automated responses or immediate alerts to security personnel.

In step 606, the method can include evaluating signals for in-depth analysis.

While some signals require immediate action, others benefit from more comprehensive examination. This step involves a deeper, more nuanced evaluation of signals that don't present immediate threats but may indicate important security trends, potential vulnerabilities, or emerging threats. The in-depth analysis might employ advanced analytics techniques, including machine learning algorithms, behavioral analysis, or complex event processing. For instance, it might involve analyzing patterns of user behavior over extended periods, correlating seemingly unrelated signals across different systems, or comparing current signal patterns with historical data to identify anomalies. This analysis could uncover subtle signs of advanced persistent threats, insider activities, or gradual security deterioration that might not be apparent in rapid evaluation. The process may also involve enriching the signals with additional context from various data sources, both internal and external, to provide a more complete picture of the security landscape. The results of this in-depth analysis are then forwarded to the decision-making step, providing valuable insights for long-term security strategy and proactive threat mitigation.

In step 608, the method can include making security decisions.

This step involves synthesizing the outputs from both the immediate threat evaluation and the in-depth analysis to determine the appropriate security response. The decision-making typically employs a combination of predefined security policies, risk assessment algorithms, and potentially machine learning models trained on historical security data. For immediate threats, the method might have a set of automatic responses configured, such as blocking an IP address, revoking user credentials, or isolating a compromised system. For insights derived from in-depth analysis, the decisions might involve updating security policies, initiating further investigations, or recommending long-term security improvements. The decision-making system can also incorporate a risk-based approach, weighing the potential impact of a security issue against the cost and disruption of potential responses. It may also consider factors such as the reliability of the signal source, the current threat landscape, and the organization's overall risk tolerance. The output of this step is a concrete decision on whether action is needed and, if so, what specific measures should be taken.

In step 610, the method can include determining if action is needed.

Based on the security decision made in the previous step, the method determines whether any action is required. This determination is typically based on predefined thresholds or policies that dictate when a security response should be triggered. For example, a high-risk signal indicating a potential data breach might always trigger an action, while a low-risk anomaly might only prompt action if it's part of a larger pattern. The decision point allows the method to filter out false positives or low-impact issues that don't warrant a response, helping to prevent alert fatigue and conserve resources for significant threats. If action is deemed necessary, the method proceeds to step 612; otherwise, it proceeds to step 614 where it continues to monitor incoming signals.

In step 612, the method can include executing security response.

When action is deemed necessary, this step involves implementing the decided security measures. The response can range from automated actions, such as updating firewall rules, forcing a password reset, or quarantining a suspicious file, to triggering alerts for human intervention. For more complex or high-impact situations, the response might involve initiating a predefined incident response plan, which could include notifying key personnel, preserving evidence for forensic analysis, or activating business continuity procedures. The execution of security responses is typically logged in detail for audit purposes and to provide data for improving future response strategies. After the response is executed, the method can initiate a feedback loop, monitoring the effectiveness of the action taken and potentially triggering further responses if the initial action doesn't fully mitigate the threat. After step 612, the method can proceed to step 614 where it continues to monitor incoming signals.

In some implementations, the dynamic security events framework operates in a continuous feedback loop. Actions taken by processors generate new events, which are then fed back into the system for analysis. This closed-loop operation allows the system to continuously refine its understanding of the security landscape, adjust its decision-making processes, and adapt to changing threat patterns in real-time. In some implementations, the framework is designed to operate in multi-tenant environments while also incorporating tenant-agnostic data sources. This allows for both tenant-specific security policies and global threat intelligence to be considered in the decision-making process. Signals can be collected and analyzed across tenants when appropriate, while still maintaining necessary isolation and data privacy between tenants.

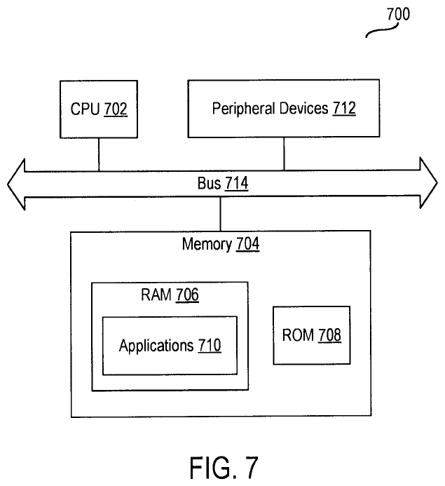

FIG. 7 is a block diagram of a computing device according to some implementations of the disclosure.

As illustrated, the device 700 includes a processor or central processing unit (CPU) such as CPU 702 in communication with a memory 704 via a bus 714. The device also includes one or more input/output (I/O) or peripheral devices 712. Examples of peripheral devices include, but are not limited to, network interfaces, audio interfaces, display devices, keypads, mice, keyboard, touch screens, illuminators, haptic interfaces, global positioning system (GPS) receivers, cameras, or other optical, thermal, or electromagnetic sensors.

In some implementations, the CPU 702 may comprise a general-purpose CPU. The CPU 702 may comprise a single-core or multiple-core CPU. The CPU 702 may comprise a system-on-a-chip (SoC) or a similar embedded system. In some implementations, a graphics processing unit (GPU) may be used in place of, or in combination with, a CPU 702. Memory 704 may comprise a memory system including a dynamic random-access memory (DRAM), static random-access memory (SRAM), Flash (e.g., NAND Flash), or combinations thereof. In one embodiment, the bus 714 may comprise a Peripheral Component Interconnect Express (PCIe) bus. In some implementations, the bus 714 may comprise multiple busses instead of a single bus.

Memory 704 illustrates an example of a non-transitory computer storage media for the storage of information such as computer-readable instructions, data structures, program modules, or other data. Memory 704 can store a basic input/output system (BIOS) in read-only memory (ROM), such as ROM 708 for controlling the low-level operation of the device. The memory can also store an operating system in random-access memory (RAM) for controlling the operation of the device.

Applications 710 may include computer-executable instructions which, when executed by the device, perform any of the methods (or portions of the methods) described previously in the description of the preceding figures. In some implementations, the software or programs implementing the method embodiments can be read from a hard disk drive (not illustrated) and temporarily stored in RAM 706 by CPU 702. CPU 702 may then read the software or data from RAM 706, process them, and store them in RAM 706 again.

The device may optionally communicate with a base station (not shown) or directly with another computing device. One or more network interfaces in peripheral devices 712 are sometimes referred to as a transceiver, transceiving device, or network interface card (NIC).

An audio interface in peripheral devices 712 produces and receives audio signals such as the sound of a human voice. For example, an audio interface may be coupled to a speaker and microphone (not shown) to enable telecommunication with others or generate an audio acknowledgment for some action. Displays in peripheral devices 712 may comprise liquid crystal display (LCD), gas plasma, light-emitting diode (LED), or any other type of display device used with a computing device. A display may also include a touch-sensitive screen arranged to receive input from an object such as a stylus or a digit from a human hand.

A keypad in peripheral devices 712 may comprise any input device arranged to receive input from a user. An illuminator in peripheral devices 712 may provide a status indication or provide light. The device can also comprise an input/output interface in peripheral devices 712 for communication with external devices, using communication technologies, such as USB, infrared, Bluetooth®, or the like. A haptic interface in peripheral devices 712 provides tactile feedback to a user of the client device.

A GPS receiver in peripheral devices 712 can determine the physical coordinates of the device on the surface of the Earth, which typically outputs a location as latitude and longitude values. A GPS receiver can also employ other geo-positioning mechanisms, including, but not limited to, triangulation, assisted GPS (AGPS), E-OTD, CI, SAI, ETA, BSS, or the like, to further determine the physical location of the device on the surface of the Earth. In one embodiment, however, the device may communicate through other components, providing other information that may be employed to determine the physical location of the device, including, for example, a media access control (MAC) address, Internet Protocol (IP) address, or the like.

The device may include more or fewer components than those shown, depending on the deployment or usage of the device. For example, a server computing device, such as a rack-mounted server, may not include audio interfaces, displays, keypads, illuminators, haptic interfaces, Global Positioning System (GPS) receivers, or cameras/sensors. Some devices may include additional components not shown, such as graphics processing unit (GPU) devices, cryptographic co-processors, artificial intelligence (AI) accelerators, or other peripheral devices.

The subject matter disclosed above may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware, or any combination thereof (other than software per se). The preceding detailed description is, therefore, not intended to be taken in a limiting sense.

Throughout the specification and claims, terms may have nuanced meanings suggested or implied in context beyond an explicitly stated meaning. Likewise, the phrase “In some implementations” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and,” “or,” or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general-purpose computer to alter its function as detailed herein, a special purpose computer, application-specific integrated circuit (ASIC), or other programmable data processing apparatus, such that the instructions, which execute via the method or of the computer or other programmable data processing apparatus, implement the functions/acts specified in the block diagrams or operational block or blocks. In some alternate implementations, the functions or acts noted in the blocks can occur out of the order noted in the operational illustrations. For example, two blocks shown in succession can in fact be executed substantially concurrently or the blocks can sometimes be executed in the reverse order, depending upon the functionality or acts involved.

We claim:

1. A method comprising:
receiving a stream of security events from a plurality of event generators;
generating security signals based on the security events, the security signals comprising a subset of the security events;
aggregating and correlating the security signals using a signal source;
evaluating the security signals and determining risk levels using a plurality of independent processors;
determining that action is required based on a combined output of the security signals and determined risk levels; and
executing a security response responsive to the action.

2. The method of claim 1, wherein receiving a stream of security events comprises: collecting raw events from the plurality of event generators; ingesting the raw events to a stream; enriching the ingested events; normalizing the enriched events; and filtering the normalized events.

3. The method of claim 1, wherein generating security signals based on the security events comprises: receiving normalized events; distributing the normalized events to analyzers including one or more of a bot detection module, a machine learning profiler module, and an anomaly detection module; analyzing the distributed events with the analyzers; generating the security signals based on output from the analyzers; and
transmitting the generated security signals to the signal source.

4. The method of claim 1, wherein aggregating and correlating the security signals comprises: receiving the security signals at the signal source; collecting and aggregating the received signals; correlating the aggregated signals to identify patterns; enriching the correlated signals with context data; and routing the enriched signals to the plurality of independent processors.

5. The method of claim 1, wherein evaluating the security signals comprises: receiving correlated signals at the plurality of independent processors; evaluating the correlated signals for immediate threats; and evaluating the correlated signals for in-depth analysis.

6. The method of claim 1, wherein determining that action is required comprises: comparing the determined risk levels against predefined thresholds or policies; determining a confidence level of a risk assessment; and proceeding to execute the security response if the risk meets or exceeds an action threshold.

7. The method of claim 1, wherein executing the security response comprises: selecting a specific response from a predefined set of actions based on a nature and severity of a detected risk; interacting with system components to implement the selected response; logging the executed response for auditing purposes; and recording a response to the action.

8. A non-transitory computer-readable storage medium for tangibly storing computer program instructions capable of being executed by a computer processor, the computer program instructions defining steps of:
receiving a stream of security events from a plurality of event generators;
generating security signals based on the security events, the security signals comprising a subset of the security events;
aggregating and correlating the security signals using a signal source;
evaluating the security signals and determining risk levels using a plurality of independent processors;
determining that action is required based on a combined output of the security signals and determined risk levels; and
executing a security response responsive to the action.

9. The non-transitory computer-readable storage medium of claim 8, wherein receiving a stream of security events comprises: collecting raw events from the plurality of event generators; ingesting the raw events to a stream; enriching the ingested events;
normalizing the enriched events; and filtering the normalized events.

10. The non-transitory computer-readable storage medium of claim 8, wherein generating security signals based on the security events comprises: receiving normalized events; distributing the normalized events to analyzers including one or more of a bot detection module, a machine learning profiler module, and an anomaly detection module; analyzing the distributed events with the analyzers; generating the security signals based on output from the analyzers; and transmitting the generated security signals to the signal source.

11. The non-transitory computer-readable storage medium of claim 8, wherein aggregating and correlating the security signals comprises: receiving the security signals at the signal source; collecting and aggregating the received signals; correlating the aggregated signals to identify patterns; enriching the correlated signals with context data; and routing the enriched signals to the plurality of independent processors.

12. The non-transitory computer-readable storage medium of claim 8, wherein evaluating the security signals comprises: receiving correlated signals at the plurality of independent processors; evaluating the correlated signals for immediate threats; and evaluating the correlated signals for in-depth analysis.

13. The non-transitory computer-readable storage medium of claim 8, wherein determining that action is required comprises: comparing the determined risk levels against predefined thresholds or policies; determining a confidence level of a risk assessment; and
proceeding to execute the security response if the risk meets or exceeds an action threshold.

14. The non-transitory computer-readable storage medium of claim 8, wherein executing the security response comprises: selecting a specific response from a predefined set of actions based on a nature and severity of a detected risk; interacting with system components to implement the selected response; logging the executed response for auditing purposes; and recording a response to the action.

15. A device comprising:
a processor; and
a storage medium for tangibly storing thereon program logic for execution by the processor, the program logic comprising steps for:
receiving a stream of security events from a plurality of event generators;
generating security signals based on the security events, the security signals comprising a subset of the security events;
aggregating and correlating the security signals using a signal source;
evaluating the security signals and determining risk levels using a plurality of independent processors;
determining that action is required based on a combined output of the security signals and determined risk levels; and
executing a security response responsive to the action.

16. The device of claim 15, wherein receiving a stream of security events comprises: collecting raw events from the plurality of event generators; ingesting the raw events to a stream; enriching the ingested events; normalizing the enriched events; and filtering the normalized events.

17. The device of claim 15, wherein generating security signals based on the security events comprises: receiving normalized events; distributing the normalized events to analyzers including one or more of a bot detection module, a machine learning profiler module, and an anomaly detection module; analyzing the distributed events with the analyzers; generating the security signals based on output from the analyzers; and transmitting the generated security signals to the signal source.

18. The device of claim 15, wherein aggregating and correlating the security signals comprises: receiving the security signals at the signal source; collecting and aggregating the received signals; correlating the aggregated signals to identify patterns; enriching the correlated signals with context data; and routing the enriched signals to the plurality of independent processors.

19. The device of claim 15, wherein evaluating the security signals comprises: receiving correlated signals at the plurality of independent processors; evaluating the correlated signals for immediate threats; and evaluating the correlated signals for in-depth analysis.

20. The device of claim 15, wherein executing the security response comprises: selecting a specific response from a predefined set of actions based on a nature and severity of a detected risk; interacting with system components to implement the selected response; logging the executed response for auditing purposes; and recording a response to the action.
